(19) United States
(12) Patent Application Publication
(10) Pub. No.: US 2023/0202510 A1
(43) Pub. Date: Jun. 29, 2023

(54) APPARATUS FOR ACQUIRING AUTONOMOUS DRIVING LEARNING DATA AND METHOD THEREOF

(71) Applicants: HYUNDAI MOTOR COMPANY, Seoul (KR); Kia Corporation, Seoul (KR)

(72) Inventor: Young Hyun KIM, Seoul (KR)

(73) Assignees: HYUNDAI MOTOR COMPANY, Seoul (KR); Kia Corporation, Seoul (KR)

(21) Appl. No.: 17/884,058

(22) Filed: Aug. 9, 2022

(30) Foreign Application Priority Data
Dec. 27, 2021 (KR) 10-2021-0188955

(51) Int. Cl. B60W 60/00; G06V 20/58

(52) U.S. Cl. CPC B60W 60/001; G06V 20/58; B60W 2420/42; B60W 2420/52

(57) ABSTRACT

The present disclosure relates to an autonomous driving learning data acquiring apparatus, which selectively acquires learning data of an autonomous vehicle, and a method thereof. According to an embodiment of the present disclosure, an information acquisition device may acquire input data of recognition logic for autonomous driving. A processor may determine whether the acquired input data is necessary for the learning of the recognition logic, through a pre-learned artificial neural network (ANN)-based learning model. A storage may storage storing input data, which is determined to be necessary for the learning of the recognition logic, from among the acquired input data. Through the present disclosure, it is possible to efficiently use a storage space of an autonomous vehicle's data storage device and to effectively acquire high-quality learning data from the autonomous vehicle driven by users.

### CROSS-REFERENCE TO RELATED APPLICATION

This application claims the benefit of priority to Korean Patent Application No. 10-2021-0188955, filed in the Korean Intellectual Property Office on Dec. 27, 2021, the entire contents of which are incorporated herein by reference.

### TECHNICAL FIELD

The present disclosure relates to an autonomous driving learning data acquiring apparatus and a method thereof, and more particularly, relates to an autonomous driving learning data acquiring apparatus, which selectively acquires learning data of an autonomous vehicle, and a method thereof.

### BACKGROUND

To develop an autonomous driving technology, it is necessary to secure ground-truth (GT) data such as various learning videos, or the like. Learning data related to the autonomous driving technology may be acquired through driving of an actual autonomous vehicle. There is a method of obtaining the learning data through a vehicle that is sold on the market and driven by a user, or a method of acquiring the learning data through an experimentally-driven vehicle. The method of the latter has limitations in terms of required time and the diversity of data to be obtained. Accordingly, the method of the former is effective to obtain data automatically transmitted from a vehicle sold on the market.

However, when this method is used, it is possible to secure a large amount of data, but various data according to the moving location of a vehicle may not be obtained. Moreover, when all pieces of input data are stored without selectively acquiring data, storage capacity may be insufficient. Furthermore, when some users operate the vehicle with malicious intent, data capable of causing errors may be acquired. Therefore, it is necessary to develop a technology for resolving these issues and efficiently acquiring learning data.

### SUMMARY

The present disclosure has been made to solve the above-mentioned problems occurring in the prior art while advantages achieved by the prior art are maintained intact.

An aspect of the present disclosure provides an autonomous driving learning data acquiring apparatus for selectively acquiring learning data of an autonomous vehicle, and a method thereof.

An aspect of the present disclosure provides an autonomous driving learning data acquiring apparatus for selectively acquiring autonomous driving learning data according to various places, and a method thereof.

An aspect of the present disclosure provides an autonomous driving learning data acquiring apparatus for efficiently using the storage space of a data storage device of an autonomous vehicle, and a method thereof.

An aspect of the present disclosure provides an autonomous driving learning data acquiring apparatus for excluding malicious autonomous driving learning data from acquired data, and a method thereof.

An aspect of the present disclosure provides an autonomous driving learning data acquiring apparatus for effectively acquiring high-quality learning data from autonomous vehicles operated by users, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an autonomous driving learning data acquiring apparatus may include an information acquisition device included in an autonomous vehicle and acquiring input data of recognition logic for autonomous driving, a processor determining whether the acquired input data is necessary for the learning of the recognition logic, through a pre-learned artificial neural network (ANN)-based learning model, and a storage storing input data, which is determined to be necessary for learning of the recognition logic, from among the acquired input data.

In an embodiment, the information acquisition device may include at least one of a camera that acquires an image of a surrounding object of the autonomous vehicle, a light detection and ranging (LiDAR) that detects a location of the surrounding object, a radio detecting and ranging (radar), or an ultrasonic sensor.

In an embodiment, the autonomous driving learning data acquiring apparatus may further include a communication device communicating with a server. The processor may determine whether it is possible to update the learning model from the server, through the communication device, and may update the learning model through the server when it is possible to update the learning model.

In an embodiment, the autonomous driving learning data acquiring apparatus may further include a communication device communicating with a server. The processor may transmit the input data stored in the storage to the server through the communication device when a predetermined data transmission condition is satisfied.

In an embodiment, the data transmission condition may include at least one of a condition that the autonomous vehicle is charged, or a condition that the autonomous vehicle is parked in a garage.

In an embodiment, the recognition logic may include logic that performs at least one of detection, recognition, classification, or segmentation for a surrounding object of the autonomous vehicle based on the acquired input data.

In an embodiment, the processor may determine whether the acquired input data is necessary for the learning of the recognition logic, through the learning model based on the acquired input data and a result of applying the acquired input data to the recognition logic.

In an embodiment, the result of applying the acquired input data to the recognition logic may include at least one of information about a two-dimensional (2D) location of a surrounding object of the autonomous vehicle, information about a three-dimensional (3D) location of the surrounding object, a type of the surrounding object, or reliability.

In an embodiment, the information about the 2D location of the surrounding object may include information about location coordinates of a bounding box of the surrounding object.

In an embodiment, the information about the 3D location of the surrounding object may include information about at least one of a location, a size, or an approach angle of the surrounding object.

In an embodiment, the processor may calculate a vector value through the learning model, and may determine whether the acquired input data is necessary for the learning of the recognition logic, based on the calculated vector value and a predetermined hyperplane in a vector space including the vector value.

In an embodiment, the processor may determine whether the acquired input data is necessary for the learning of the recognition logic, through the ANN-based learning model including at least one of one or more convolutional neural networks, batch normalization, or an activation layer.

In an embodiment, the processor may determine whether the acquired input data is necessary for the learning of the recognition logic, based on whether a result value output through the learning model exceeds a predetermined threshold value.

According to an aspect of the present disclosure, an autonomous driving learning data acquiring method may include acquiring, by an information acquisition device included in an autonomous vehicle, input data of recognition logic for autonomous driving, determining, by a processor, whether the acquired input data is necessary for learning of the recognition logic, through a pre-learned ANN-based learning model, and controlling, by the processor, a storage to store input data, which is determined to be necessary for the learning of the recognition logic, from among the acquired input data.

In an embodiment, an autonomous driving learning data acquiring method may further include transmitting, by the processor, the input data stored in the storage to a server through a communication device communicating with the server when a predetermined data transmission condition is satisfied.

In an embodiment, the determining, by the processor, of whether the acquired input data is necessary for the learning of the recognition logic, through the pre-learned ANN-based learning model may include determining, by the processor, whether the acquired input data is necessary for the learning of the recognition logic, through the learning model based on the acquired input data and a result of applying the acquired input data to the recognition logic.

In an embodiment, the result of applying the acquired input data to the recognition logic may include at least one of information about a two-dimensional (2D) location of a surrounding object of the autonomous vehicle, information about a three-dimensional (3D) location of the surrounding object, a type of the surrounding object, or reliability.

In an embodiment, the determining, by the processor, of whether the acquired input data is necessary for the learning of the recognition logic, through the pre-learned ANN-based learning model may include calculating, by the processor, a vector value through the learning model and determining, by the processor, whether the acquired input data is necessary for the learning of the recognition logic, based on the calculated vector value and a predetermined hyperplane in a vector space including the vector value.

In an embodiment, the determining, by the processor, of whether the acquired input data is necessary for the learning of the recognition logic, through the pre-learned ANN-based learning model may include determining, by the processor, whether the acquired input data is necessary for the learning of the recognition logic, through the ANN-based learning model including at least one of one or more convolutional neural networks, batch normalization, or an activation layer.

In an embodiment, the determining, by the processor, of whether the acquired input data is necessary for the learning of the recognition logic, through the pre-learned ANN-based learning model may include determining, by the processor, whether the acquired input data is necessary for the learning of the recognition logic, based on whether a result value output through the learning model exceeds a predetermined threshold value.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an autonomous driving learning data acquiring apparatus, according to an embodiment of the present disclosure;

FIG. 2 is a flowchart illustrating a process in which an autonomous driving learning data acquiring apparatus determines data necessary for learning of recognition logic, according to an embodiment of the present disclosure;

FIG. 3 is a flowchart illustrating a process of transmitting learning data stored by an autonomous driving learning data acquiring apparatus to a server, according to an embodiment of the present disclosure;

FIG. 4 is a flowchart illustrating a process, in which an autonomous driving learning data acquiring apparatus updates a learning model for determining data necessary for learning of recognition logic from a server, according to an embodiment of the present disclosure;

FIG. 5 is a diagram illustrating recognition logic for an autonomous driving learning data acquiring apparatus, according to an embodiment of the present disclosure;

FIG. 6 is a diagram illustrating a learning model for determining data necessary for learning of recognition logic, according to an embodiment of the present disclosure;

FIG. 7 is a diagram illustrating a vector output by a learning model for determining data required for learning of recognition logic, according to an embodiment of the present disclosure; and

FIG. 8 is a flowchart illustrating a method for acquiring autonomous driving learning data, according to an embodiment of the present disclosure.

### DETAILED DESCRIPTION

Hereinafter, some embodiments of the present disclosure will be described in detail with reference to the accompanying drawings. In adding reference numerals to components of each drawing, it should be noted that the same components have the same reference numerals, although they are indicated on another drawing. Furthermore, in describing the embodiments of the present disclosure, detailed descriptions associated with well-known functions or configurations will be omitted when they may make subject matters of the present disclosure unnecessarily obscure.

In describing elements of exemplary embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

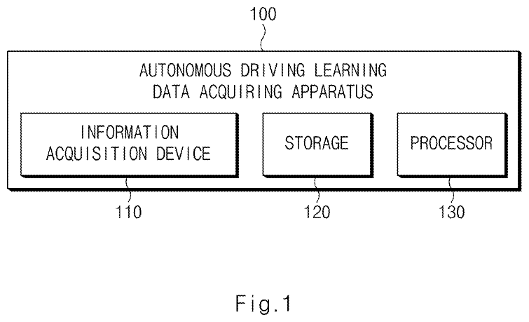

Hereinafter, various embodiments of the present disclosure will be described in detail with reference to FIGS. 1 to 8.

FIG. 1 is a block diagram illustrating an autonomous driving learning data acquiring apparatus, according to an embodiment of the present disclosure.

An autonomous driving learning data acquiring apparatus 100 according to an embodiment of the present disclosure may be implemented inside or outside a vehicle. At this time, the autonomous driving learning data acquiring apparatus 100 may be integrated with internal control units of a vehicle and may be implemented with a separate hardware device so as to be connected to control units of the vehicle by means of a connection means.

For example, the autonomous driving learning data acquiring apparatus 100 may be implemented integrally with a vehicle or may be implemented in a shape installed/attached to the vehicle as a configuration separate from the vehicle. Alternatively, a part of the autonomous driving learning data acquiring apparatus 100 may be implemented integrally with the vehicle, and the other parts may be implemented in a shape installed/attached to the vehicle as a configuration separate from the vehicle.

Referring to FIG. 1, the autonomous driving learning data acquiring apparatus 100 may include an information acquisition device 110, a storage 120, and a processor 130.

The information acquisition device 110 may be equipped in an autonomous vehicle so as to acquire input data of recognition logic related to autonomous driving.

For example, the recognition logic may include logic that performs at least one of detection, recognition, classification, or segmentation for a surrounding object of the autonomous vehicle based on input data.

For example, the recognition logic may be implemented by including a pre-learned artificial neural network (ANN)-based learning model.

For example, the recognition logic may be implemented by including the ANN-based learning model including at least one of one or more convolutional neural networks, batch-normalization, or an activation layer.

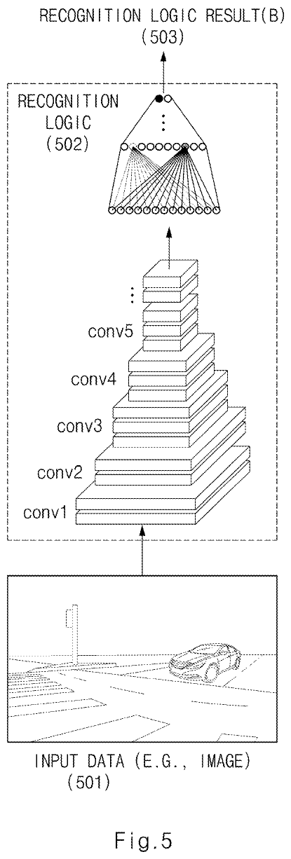

The recognition logic will be described in detail later with reference to FIG. 5.

For example, the information acquisition device 110 may include at least one of a camera that acquires an image of a surrounding object of an autonomous vehicle, a light detection and ranging (LiDAR) that detects a location of the surrounding object, a radio detecting and ranging (radar), or an ultrasonic sensor.

At this time, input data for the recognition logic may include at least one of a camera image, LiDAR sensor data, radar sensor data, ultrasonic sensor data, or in-vehicle communication signals (e.g., controller area network (CAN) signals) for such the data.

For example, the information acquisition device 110 may be connected to the processor 130 through wireless or wired communication, and may directly or indirectly deliver the acquired input data to the processor 130.

The storage 120 may store input data, which is determined to be necessary for learning of the recognition logic, from among input data.

For example, the storage 120 may include at least one type of a storage medium among a flash memory type of a memory, a hard disk type of a memory, a micro type of a memory, or a card type (e.g., a Secure Digital (SD) card or an eXtream Digital (XD) card) of a memory, a random access memory (RAM) type of a memory, a static RAM (SRAM) type of a memory, a read-only memory (ROM) type of a memory, a programmable ROM (PROM) type of a memory, an electrically erasable PROM (EEPROM) type of a memory, a magnetic RAM (MRAM) type of a memory, a magnetic disc type of a memory, or an optical disc type of a memory.

For example, the storage 120 may store at least one of data received through the information acquisition device 110, data required to operate the processor 130, an algorithm required to operate the processor 130, the recognition logic, or a pre-learned ANN-based learning model.

For example, the storage 120 may be connected to the information acquisition device 110 and/or the processor 130 so as to provide stored information to the information acquisition device 110 and/or the processor 130.

The processor 130 may be electrically connected to the information acquisition device 110, the storage 120, or the like, may electrically control each of the components, may be an electrical circuit that executes the instructions of the software, and may perform various data processing and calculation described below. The processor 130 may be, for example, an electronic control unit (ECU), a Micro Controller Unit (MCU), or another sub-controller, which is mounted in the vehicle.

The processor 130 may determine whether the acquired input data is necessary for the learning of the recognition logic, through the pre-learned ANN-based learning model.

As an example, the pre-learned ANN-based learning model may evaluate the quality of input data.

The pre-learned ANN may be stored in the storage 120 when an autonomous vehicle is manufactured, or may be downloaded from a server after the autonomous vehicle is manufactured.

For example, the processor 130 may determine whether the acquired input data is necessary for the learning of the recognition logic, through the ANN-based learning model including at least one of one or more convolutional neural networks, batch normalization, or an activation layer.

For example, a learning model for determining whether the acquired input data is necessary for the learning of recognition logic may include one or more convolution layers.

For example, the learning model for determining whether the acquired input data is necessary for the learning of the recognition logic may include a layer for normalizing data for each layer such that a transformed distribution is not output.

For example, the learning model for determining whether the acquired input data is necessary for the learning of the recognition logic may include an activation function-based activation layer such as a rectified linear unit (ReLU).

For example, the processor 130 may determine whether the acquired input data is necessary for the learning of the recognition logic, through the learning model based on the acquired input data and a result of applying the acquired input data to the recognition logic.

For example, the processor 130 may determine whether the acquired input data is necessary for the learning of the recognition logic, by using the result of applying the acquired input data to the recognition logic and the merged data as an input value of the learning model.

For example, the result of applying the acquired input data to the recognition logic may include at least one of information about a two-dimensional (2D) location of a surrounding object of an autonomous vehicle, information about a three-dimensional (3D) location of the surrounding object, the type of the surrounding object, or reliability.

For example, the processor 130 may determine whether the acquired input data is necessary for the learning of the recognition logic, by using data, which is obtained by merging the acquired input data and at least one of the information about the 2D location of the surrounding object of the autonomous vehicle, the information about the 3D location of the surrounding object, the type of the surrounding object, or the reliability, as the input value of the model.

For example, the information about the 2D location of the surrounding object may include information about location coordinates of a bounding box of the surrounding object.

For example, the information about the 2D location of the surrounding object may include information about location coordinates the bounding box of the surrounding object positioned in an image or information about location coordinates of the bounding box of the surrounding object located on the 2D coordinate system through sensor information acquired through other sensors.

For example, the information about the 2D location of the surrounding object may include information about the minimum value of X coordinate, the minimum value of Y coordinate, the maximum value of X coordinate, and the maximum value of Y coordinate of the bounding box of the surrounding object.

For example, the processor 130 may calculate information about the minimum value of X coordinate, the minimum value of Y coordinate, the maximum value of X coordinate, and the maximum value of Y coordinate of the bounding box of the surrounding object.

For example, the information about the 3D location of the surrounding object may include information about at least one of a location, size, or approach angle of the surrounding object.

For example, the information about the 3D location of the surrounding object may include information about the X coordinate, Y coordinate, and Z coordinate of a center or feature point of the surrounding object.

For example, the information about the 3D location of the surrounding object may include information about the overall height, overall width, and overall length of the surrounding object.

For example, the information about the 3D location of the surrounding object may include information about an angle of the traveling direction of the surrounding object based on the traveling direction of the autonomous vehicle.

For example, the processor 130 may calculate a vector value through the learning model and then may determine whether the acquired input data is necessary for the learning of the recognition logic, based on the calculated vector value and a predetermined hyperplane in a vector space including the vector value.

In particular, the processor 130 may calculate one vector in an intermediate stage of a process of calculating the result value through the learning model. Moreover, the processor 130 may evaluate the calculated one vector through the predetermined hyperplane that is a criterion for determination, and then may determine whether the acquired input data is necessary for the learning of the recognition logic.

For example, the processor 130 may determine whether the acquired input data is necessary for the learning of the recognition logic, based on whether a result value output through the learning model exceeds a predetermined threshold value.

In particular, the processor 130 may calculate one final result value through the learning model. The result value may be a real number between 0 and 1. Also, the processor 130 may determine whether the acquired input data is necessary for the learning of the recognition logic, based on whether the calculated result value is not less than a specific threshold value.

Although not shown, the autonomous driving learning data acquiring apparatus 100 may further include a communication device that communicates with a server.

For example, the communication device (not illustrated) may transmit/receive data with the server by using various communication methods. For example, the communication device (not illustrated) may use Wi-Fi, Bluetooth, Zigbee, Ultra-Wide Band (UWB) communication, and a near field communication (NFC) method.

For example, the communication device (not illustrated) may communicate with the server in real time or at specific intervals.

For example, the server that communicates with the communication device (not illustrated) may refer to a server that collects, stores, and manages autonomous driving learning data.

For example, the processor 130 may determine whether it is possible to update the learning model from the server, through the communication device (not illustrated). When it is possible to update the learning model, the processor 130 may update the learning model through the server.

For example, when it is identified that it is possible to update the learning model for determining whether the input data is necessary for learning of the recognition logic, the processor 130 may download an update file from the server and then may update the learning model for determining whether the input data stored in the storage 120 is necessary for the learning of the recognition logic.

For example, when the predetermined data transmission condition is satisfied, the processor 130 may transmit the input data stored in the storage 120 to the server through the communication device (not illustrated).

For example, the input data transmitted to the server may be data to be collected, stored, and managed as autonomous driving learning data, which is a function of the server described above.

In addition, after the input data stored in the storage 120 is transmitted to the server, the server may use the autonomous driving learning data collected, stored, and managed based on the received input data to generate the latest version of the learning model.

For example, when driving of autonomous vehicle is terminated and then it is determined that an environment is suitable for transmitting data to the server, the processor 130 may transmit the input data stored in the storage 120 to the server through the communication device (not illustrated).

For example, the data transmission condition may include at least one of a condition that the autonomous vehicle is charged, or a condition that the autonomous vehicle is parked in a garage.

For example, to identify the data transmission condition, the processor 130 may be connected to a battery management system (BMS) of the autonomous vehicle so as to determine whether the autonomous vehicle is being charged.

For example, to identify the data transmission condition, the processor 130 may be connected to a global positioning system (GPS) of the autonomous vehicle so as to determine whether the autonomous vehicle is being charged.

For example, when driving of the autonomous vehicle is terminated and then the autonomous vehicle is an electric vehicle and is charged at a charging station, or when the autonomous vehicle is a fleet vehicle and is parked in a garage, the processor 130 may determine that an environment is suitable for transmitting data to the server, and then may transmit the input data stored in the storage 120 to the server through the communication device (not illustrated).

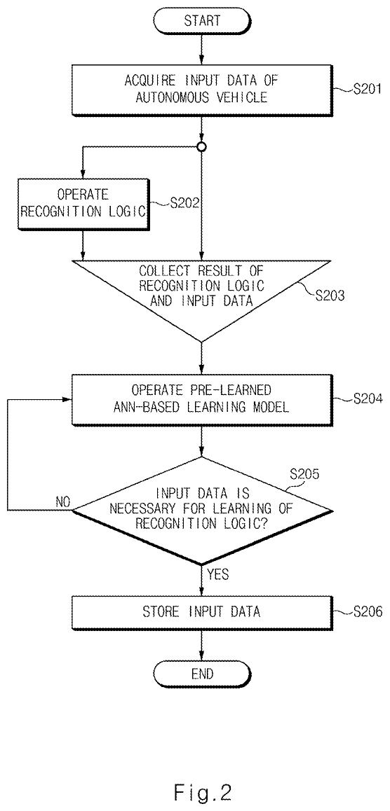

FIG. 2 is a flowchart illustrating a process in which an autonomous driving learning data acquiring apparatus determines data necessary for learning of recognition logic, according to an embodiment of the present disclosure.

Referring to FIG. 2, the autonomous driving learning data acquiring apparatus 100 may acquire input data of an autonomous vehicle (S201).

For example, the autonomous driving learning data acquiring apparatus 100 may acquire data associated with autonomous driving through various sensors equipped in the autonomous vehicle.

The autonomous driving learning data acquiring apparatus 100 may operate recognition logic (S202).

For example, the autonomous driving learning data acquiring apparatus 100 may calculate a result of the recognition logic by operating the recognition logic that recognizes a surrounding environment of the autonomous vehicle by using the acquired input data as an input.

The autonomous driving learning data acquiring apparatus 100 may collect the result of the recognition logic and the input data (S203).

For example, the autonomous driving learning data acquiring apparatus 100 may generate new data obtained by merging the result of the recognition logic and the input data.

The autonomous driving learning data acquiring apparatus 100 may operate a pre-learned ANN-based learning model (S204).

For example, the autonomous driving learning data acquiring apparatus 100 may operate the pre-learned ANN-based learning model by using the new data, which is obtained by merging the result of the recognition logic and the input data, as an input.

Through the learning model, the autonomous driving learning data acquiring apparatus 100 may determine whether the input data is necessary for the learning of the recognition logic (S205).

For example, the autonomous driving learning data acquiring apparatus 100 may determine whether input data is necessary for the learning of the recognition logic, based on an output value of the learning model that uses the new data, which is obtained by merging the result of the recognition logic and the input data, as an input.

When it is identified that the input data is not necessary for the learning of the recognition logic, the autonomous driving learning data acquiring apparatus 100 may return to S204 again and may operate the pre-learned ANN-based learning model.

When it is identified that the input data is necessary for the learning of the recognition logic, the autonomous driving learning data acquiring apparatus 100 may store the input data (S206).

For example, when it is identified that the input data is necessary for the learning of the recognition logic, the autonomous driving learning data acquiring apparatus 100 may store the input data in the storage 120. When it is identified that the input data is not necessary for the learning of the recognition logic, the autonomous driving learning data acquiring apparatus 100 may not store the input data.

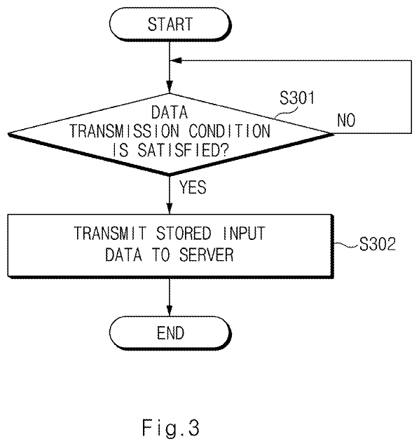

FIG. 3 is a flowchart illustrating a process of transmitting learning data stored by an autonomous driving learning data acquiring apparatus to a server, according to an embodiment of the present disclosure.

Referring to FIG. 3, the autonomous driving learning data acquiring apparatus 100 may determine whether a data transmission condition is satisfied (S301).

For example, the autonomous driving learning data acquiring apparatus 100 may determine whether an autonomous vehicle is in an environment (a condition that an autonomous vehicle is being charged at a charging station when the autonomous vehicle is an electric vehicle, or the condition that the autonomous vehicle is parked in a garage when the autonomous vehicle is a fleet vehicle) suitable to transmitting data to a server after the driving of the autonomous vehicle is terminated.

When it is identified that the data transmission condition is not satisfied, the autonomous driving learning data acquiring apparatus 100 may return to S301 again and may determine whether the data transmission condition is satisfied.

When it is identified that the data transmission condition is satisfied, the autonomous driving learning data acquiring apparatus 100 may transmit the stored input data to the server (S302).

For example, the input data transmitted to the server may be data to be collected, stored, and managed as autonomous driving learning data, which is a function of the server described above.

In addition, after the input data stored in the storage 120 is transmitted to the server, the server may use the autonomous driving learning data collected, stored, and managed based on the received input data to generate the latest version of the learning model.

The autonomous driving learning data acquiring apparatus 100 may identify the data transmission condition. Only when the condition is satisfied, the autonomous driving learning data acquiring apparatus 100 may transmit data to the server, thereby achieving the stability of an autonomous vehicle.

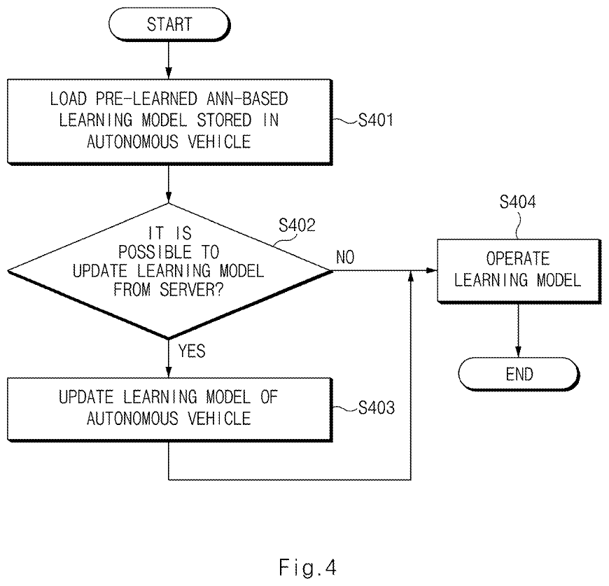

FIG. 4 is a flowchart illustrating a process, in which an autonomous driving learning data acquiring apparatus updates a learning model for determining data necessary for learning of recognition logic from a server, according to an embodiment of the present disclosure.

Referring to FIG. 4, the autonomous driving learning data acquiring apparatus 100 may load a pre-learned ANN-based learning model stored in an autonomous vehicle (S401).

For example, when input data is acquired, the autonomous driving learning data acquiring apparatus 100 may load the pre-learned ANN-based learning model stored in the storage 120.

The autonomous driving learning data acquiring apparatus 100 may determine whether it is possible to update the learning model from a server (S402).

For example, the autonomous driving learning data acquiring apparatus 100 may determine whether it is possible to update the learning model, which is stored in the storage 120 and which determines whether the input data is necessary for learning of recognition logic, by communicating with the server through a communication device.

When it is identified that it is possible to update the learning model from the server, the autonomous driving learning data acquiring apparatus 100 may update the learning model of the autonomous vehicle (S403).

For example, the autonomous driving learning data acquiring apparatus 100 may download an update file from the server through the communication device and then may update the learning model, which is stored in the storage 120 and which determines whether the input data is necessary for the learning of the recognition logic, to the latest version.

The autonomous driving learning data acquiring apparatus 100 may update the learning model of the autonomous vehicle (S403), and then may operate the learning model (S404).

For example, the autonomous driving learning data acquiring apparatus 100 may determine whether the input data is necessary for the learning of the recognition logic, by operating the updated learning model of the latest version.

When it is identified that it is not possible to update the learning model from the server, the autonomous driving learning data acquiring apparatus 100 may operate the learning model (S404).

When it is identified that it is not possible to update the learning model from the server, because the learning model previously stored in the storage 120 has the latest version, the autonomous driving learning data acquiring apparatus 100 may determine whether the input data is necessary for the learning of the recognition logic, by operating the stored learning model.

FIG. 5 is a diagram illustrating recognition logic for an autonomous driving learning data acquiring apparatus, according to an embodiment of the present disclosure.

Referring to FIG. 5, recognition logic 502 for recognizing a surrounding environment of an autonomous vehicle may be implemented through a pre-learned ANN-based learning model.

For example, the recognition logic 502 may operate by receiving input data including surrounding images of the autonomous vehicle as an input.

As another example not shown, the recognition logic may operate by receiving, as an input, at least one of LiDAR sensor data, radar sensor data, ultrasonic sensor data, or in-vehicle communication signals for these data.

For example, the ANN-based learning model implementing the recognition logic 502 may include one or more convolutional layers (conv1, conv2, conv3, conv4, conv5, . . . ).

For example, each convolutional layer may include a layer that normalizes data.

For example, the recognition logic 502 may calculate a final recognition logic result 503 by using data, which is to be calculated as input data 501 passes through the convolutional layers (conv1, conv2, conv3, conv4, conv5, . . . ), as an input of one or more dense layers or fully-connected layers.

For example, the recognition logic result 503 may include at least one of information about a location of a surrounding object of the autonomous vehicle, information about the type of the surrounding object of the autonomous vehicle, or information about the reliability of perception.

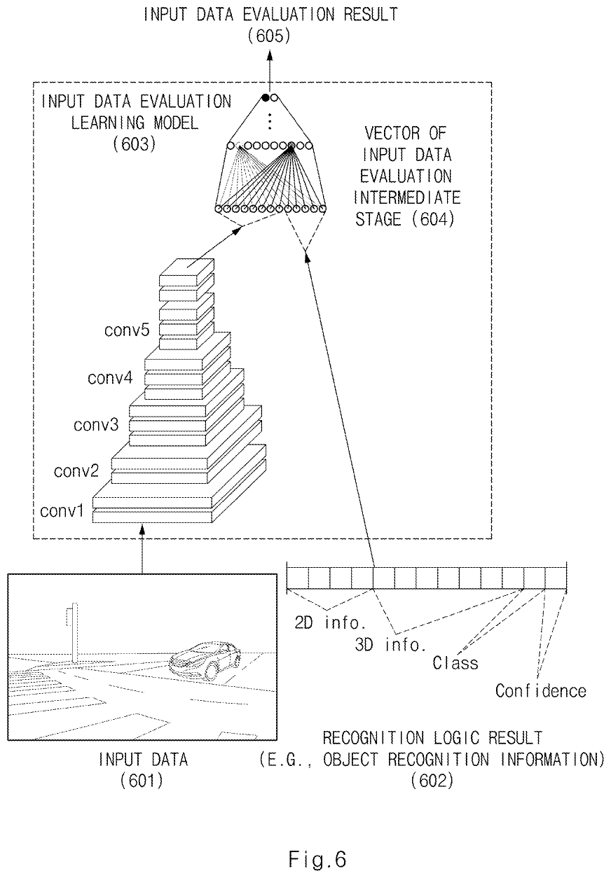

FIG. 6 is a diagram illustrating a learning model for determining data necessary for learning of recognition logic, according to an embodiment of the present disclosure.

Referring to FIG. 6, an input data evaluation learning model 603 may calculate an input data evaluation result 605 based on input data 601 and a recognition logic result 602.

For example, the input data evaluation learning model 603 may be implemented through a pre-learned ANN-based learning model.

For example, the input data evaluation learning model 603 may include one or more convolutional layers (conv1, conv2, conv3, conv4, conv5, . . . ).

Here, a convolutional layer structure used in the input data evaluation learning model 603 may be different from a convolutional layer structure used in the recognition model 502.

For example, the input data 601 may include at least one of a camera image of an autonomous vehicle, LiDAR sensor data, radar sensor data, ultrasonic sensor data, or in-vehicle communication signals for such the data.

For example, the input data 601 may be the same as the input data 501 of the recognition logic 502.

For example, the recognition logic result 602 may include object recognition information.

For example, the recognition logic result 602 may include data obtained by merging one or more of information about a 2D location of a surrounding object of the autonomous vehicle, information about a 3D location of the surrounding object, the type of the surrounding object, and reliability.

For example, the input data evaluation learning model 603 may finally calculate the input data evaluation result 605 by using an output value, which is calculated by applying the input data 601 to one or more convolutional layers, and data from merging the recognition logic result 602 as inputs of one or more dense layers or fully-connected layers.

For example, the input data evaluation result 605 may be a real value between 0 and 1.

For example, the autonomous driving learning data acquiring apparatus 100 may determine whether the input data 601 is necessary for learning of the recognition logic, based on whether the input data evaluation result 605 is not less than a specific threshold value.

For example, in a process of calculating the input data evaluation result 605, the input data evaluation learning model 603 may calculate a vector 604 of one input data evaluation intermediate stage.

For example, the autonomous driving learning data acquiring apparatus 100 may evaluate the input data 601 based on the vector 604 of the input data evaluation intermediate stage.

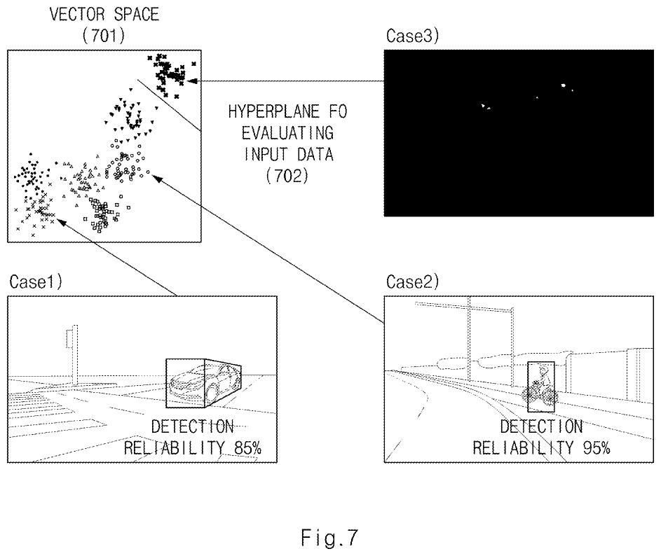

This will be described in detail with reference to FIG. 7 illustrated below.

FIG. 7 is a diagram illustrating a vector output by a learning model for determining data required for learning of recognition logic, according to an embodiment of the present disclosure.

Referring to FIG. 7, a vector of an input data evaluation intermediate stage may be specified on a vector space 701.

For example, the autonomous driving learning data acquiring apparatus 100 may evaluate input data based on a hyperplane 702 for evaluating the input data defined in the vector space 701.

For example, the autonomous driving learning data acquiring apparatus 100 may determine whether the input data is necessary for learning of recognition logic, depending on a location of a vector of the input data evaluation intermediate stage based on the hyperplane 702 in the vector space 701.

Image data of case1 may be image data indicating that a surrounding vehicle passes an intersection with a crosswalk and then passes by an autonomous vehicle. The detection reliability for the surrounding vehicle may be 85%.

Image data of case2 may be image data indicating that a bicycle passes by a road. The detection reliability for the bicycle may be 95%.

Image data of case3 may refer to an image for an extreme low-light situation. The image data of case3 may be an image indicating that a target object is not capable of being identified.

For example, vectors of the input data evaluation intermediate stage corresponding to case1 and case2 may be located in the same direction with respect to a hyperplane 702 in the vector space 701. A vector of the input data evaluation intermediate stage corresponding to case3 may be located in a different direction with respect to the hyperplane 702 in the vector space 701.

In this case, the autonomous driving learning data acquiring apparatus 100 may determine that the input data corresponding to case1 and case2 is necessary for learning of recognition logic data. The autonomous driving learning data acquiring apparatus 100 may determine that the input data corresponding to case3 is not necessary for the learning of the recognition logic data.

Through this method, the autonomous driving learning data acquiring apparatus 100 may identify damaged data or data in situations that are unnecessary for learning of recognition logic.

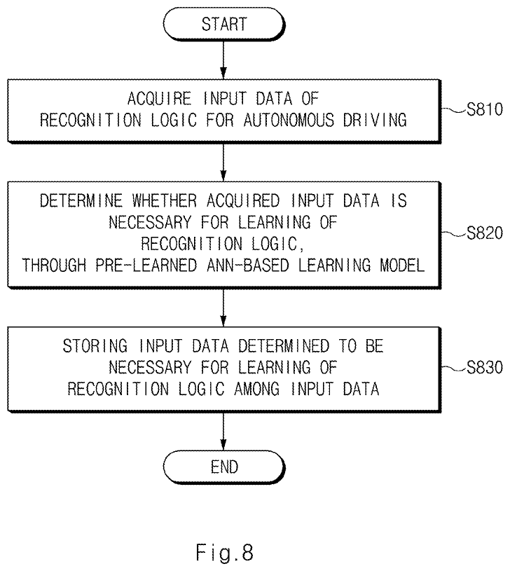

FIG. 8 is a flowchart illustrating a method for acquiring autonomous driving learning data, according to an embodiment of the present disclosure.

Referring to FIG. 8, an autonomous driving learning data acquiring method may include a step of acquiring input data of recognition logic for autonomous driving (S810), a step of determining whether the acquired input data is necessary for learning of the recognition logic through a pre-learned ANN-based learning model (S820), and a step of storing the input data determined to be necessary for the learning of the recognition logic among the input data (S830).

The step of acquiring the input data of the recognition logic for the autonomous driving (S810) may be performed by the information acquisition device 110.

The step of determining whether the acquired input data is necessary for the learning of the recognition logic through the pre-learned ANN-based learning model (S820) may be performed by the processor 130.

The step of determining whether the acquired input data is necessary for the learning of the recognition logic (S820) may include a step of determining, by the processor 130, whether the acquired input data is necessary for the learning of the recognition logic, through the learning model based on the acquired input data and a result of applying the acquired input data to the recognition logic.

For example, the step of determining whether the acquired input data is necessary for the learning of the recognition logic (S820) may include a step of calculating, by the processor 130, a vector value through the learning model and a step of determining, by the processor 130, whether the acquired input data is necessary for the learning of the recognition logic, based on the calculated vector value and a predetermined hyperplane in a vector space including the vector value.

For example, the step of determining whether the acquired input data is necessary for the learning of the recognition logic (S820) may include a step of determining, by the processor 130, whether the acquired input data is necessary for the learning of the recognition logic, through the ANN-based learning model including at least one of one or more convolutional neural networks, batch normalization, or an activation layer.

For example, the step of determining whether the acquired input data is necessary for the learning of the recognition logic (S820) may include a step of determining, by the processor 130, whether the acquired input data is necessary for the learning of the recognition logic, based on whether a result value output through the learning model exceeds a predetermined threshold value.

The step of storing the input data determined to be necessary for the learning of the recognition logic among the input data (S830) may be performed by the processor 130.

Although not illustrated, the autonomous driving learning data acquiring method may further include a step of transmitting, by the processor 130, the input data stored in the storage 120 to a server through a communication device communicating with the server when a predetermined data transmission condition is satisfied.

The operations of the method or algorithm described in connection with the embodiments disclosed in the specification may be directly implemented with a hardware module, a software module, or a combination of the hardware module and the software module, which is executed by the processor. The software module may reside on a non-transitory computer-readable storage medium (i.e., the memory and/or the storage) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The exemplary storage medium may be coupled to the processor. The processor may read out information from the storage medium and may write information in the storage medium. Alternatively, the storage medium may be integrated with the processor. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of autonomous driving learning data acquiring apparatus according to an embodiment of the present disclosure, and a method thereof are as follows.

According to at least one of embodiments of the present disclosure, it is possible to provide an autonomous driving learning data acquiring apparatus for selectively acquiring learning data of an autonomous vehicle, and a method thereof.

Furthermore, according to at least one of embodiments of the present disclosure, it is possible to provide an autonomous driving learning data acquiring apparatus for selectively acquiring autonomous driving learning data according to various places, and a method thereof.

Moreover, according to at least one of embodiments of the present disclosure, it is possible to provide an autonomous driving learning data acquiring apparatus for efficiently using the storage space of a data storage device of an autonomous vehicle, and a method thereof.

Besides, according to at least one of embodiments of the present disclosure, it is possible to provide an autonomous driving learning data acquiring apparatus for excluding malicious autonomous driving learning data from acquired data, and a method thereof.

Also, according to at least one of embodiments of the present disclosure, it is possible to provide an autonomous driving learning data acquiring apparatus for effectively acquiring high-quality learning data from autonomous vehicles operated by users, and a method thereof.

Besides, a variety of effects directly or indirectly understood through the specification may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An autonomous driving learning data acquiring apparatus, the apparatus comprising:
an information acquisition device included in an autonomous vehicle and configured to acquire input data of recognition logic for autonomous driving;
a processor configured to determine whether the acquired input data is necessary for the learning of the recognition logic, through a pre-learned artificial neural network (ANN)-based learning model; and
a storage configured to store input data, which is determined to be necessary for learning of the recognition logic, from among the acquired input data.

2. The apparatus of claim 1, wherein the information acquisition device includes:
at least one of a camera that acquires an image of a surrounding object of the autonomous vehicle, a light detection and ranging (LiDAR) that detects a location of the surrounding object, a radio detecting and ranging (radar), or an ultrasonic sensor.

3. The apparatus of claim 1, further comprising:
a communication device configured to communicate with a server,
wherein the processor is configured to:
determine whether it is possible to update the learning model from the server, through the communication device; and
update the learning model through the server when it is possible to update the learning model.

4. The apparatus of claim 1, further comprising:
a communication device configured to communicate with a server,
wherein the processor is configured to:
transmit the input data stored in the storage to the server through the communication device when a predetermined data transmission condition is satisfied.

5. The apparatus of claim 4, wherein the data transmission condition includes:
at least one of a condition that the autonomous vehicle is charged, or a condition that the autonomous vehicle is parked in a garage.

6. The apparatus of claim 1, wherein the recognition logic includes:
logic that performs at least one of detection, recognition, classification, or segmentation for a surrounding object of the autonomous vehicle based on the acquired input data.

7. The apparatus of claim 1, wherein the processor is configured to:
determine whether the acquired input data is necessary for the learning of the recognition logic, through the learning model based on the acquired input data and a result of applying the acquired input data to the recognition logic.

8. The apparatus of claim 7, wherein the result of applying the acquired input data to the recognition logic includes:
at least one of information about a two-dimensional (2D) location of a surrounding object of the autonomous vehicle, information about a three-dimensional (3D) location of the surrounding object, a type of the surrounding object, or reliability.

9. The apparatus of claim 8, wherein the information about the 2D location of the surrounding object includes:
information about location coordinates of a bounding box of the surrounding object.

10. The apparatus of claim 8, wherein the information about the 3D location of the surrounding object includes:
information about at least one of a location, a size, or an approach angle of the surrounding object.

11. The apparatus of claim 1, wherein the processor is configured to:
calculate a vector value through the learning model; and
determine whether the acquired input data is necessary for the learning of the recognition logic, based on the calculated vector value and a predetermined hyperplane in a vector space including the vector value.

12. The apparatus of claim 1, wherein the processor is configured to:
determine whether the acquired input data is necessary for the learning of the recognition logic, through the ANN-based learning model including at least one of one or more convolutional neural networks, batch normalization, or an activation layer.

13. The apparatus of claim 1, wherein the processor is configured to:
determine whether the acquired input data is necessary for the learning of the recognition logic, based on whether a result value output through the learning model exceeds a predetermined threshold value.

14. An autonomous driving learning data acquiring method, the method comprising:
acquiring, by an information acquisition device included in an autonomous vehicle, input data of recognition logic for autonomous driving;
determining, by a processor, whether the acquired input data is necessary for learning of the recognition logic, through a pre-learned ANN-based learning model; and
controlling, by the processor, a storage to store input data, which is determined to be necessary for the learning of the recognition logic, from among the acquired input data.

15. The method of claim 14, further comprising:
transmitting, by the processor, the input data stored in the storage to a server through a communication device communicating with the server when a predetermined data transmission condition is satisfied.

16. The method of claim 14, wherein the determining, by the processor, of whether the acquired input data is necessary for the learning of the recognition logic, through the pre-learned ANN-based learning model includes:
determining, by the processor, whether the acquired input data is necessary for the learning of the recognition logic, through the learning model based on the acquired input data and a result of applying the acquired input data to the recognition logic.

17. The method of claim 16, wherein the result of applying the acquired input data to the recognition logic includes:
at least one of information about a 2D location of a surrounding object of the autonomous vehicle, information about a 3D location of the surrounding object, a type of the surrounding object, or reliability.

18. The method of claim 14, wherein the determining, by the processor, of whether the acquired input data is necessary for the learning of the recognition logic, through the pre-learned ANN-based learning model includes:
calculating, by the processor, a vector value through the learning model; and
determining, by the processor, whether the acquired input data is necessary for the learning of the recognition logic, based on the calculated vector value and a predetermined hyperplane in a vector space including the vector value.

19. The method of claim 14, wherein the determining, by the processor, of whether the acquired input data is necessary for the learning of the recognition logic, through the pre-learned ANN-based learning model includes:
determining, by the processor, whether the acquired input data is necessary for the learning of the recognition logic, through the ANN-based learning model including at least one of one or more convolutional neural networks, batch normalization, or an activation layer.

20. The method of claim 14, wherein the determining, by the processor, of whether the acquired input data is necessary for the learning of the recognition logic, through the pre-learned ANN-based learning model includes:
determining, by the processor, whether the acquired input data is necessary for the learning of the recognition logic, based on whether a result value output through the learning model exceeds a predetermined threshold value.
